(19) United States
(12) Patent Application Publication
(10) Pub. No.: US 2015/0105019 A1
(43) Pub. Date: Apr. 16, 2015

(54) WIRELESS COMMUNICATION DEVICE AND WIRELESS PARING METHOD THEREOF

(71) Applicant: ACER INCORPORATED, New Taipei City (TW)

(72) Inventors: Chien-Lung Liu, New Taipei City (TW); Ching-Ho Tsai, New Taipei City (TW); Po-Chang Yang, New Taipei City (TW); Harianto Siek, New Taipei City (TW)

(73) Assignee: ACER INCORPORATED, New Taipei City (TW)

(21) Appl. No.: 14/101,346

(22) Filed: Dec. 10, 2013

(30) Foreign Application Priority Data
Oct. 11, 2013 (TW) 102136825

(51) Int. Cl. H04W 84/18

(52) U.S. Cl. CPC H04W 84/18
USPC 455/41.2

(57) ABSTRACT

A wireless communication device and a wireless paring method thereof provided. The method is suitable for a first wireless communication device. The first wireless communication device includes a storing module storing a first operation system(OS) and a second OS. The method includes: executing the first OS, and executing a wireless paring of the first wireless communication device and a second wireless communication device through the first OS; storing a paring information into a sharing information backup region of the storing module through the first OS; executing the second OS, and reading the paring information from the sharing information backup region through the second OS; and establishing a wireless connection between the first wireless communication device and the second wireless communication device through the second OS according to the paring information.

### CROSS-REFERENCE TO RELATED APPLICATION

This application claims the priority benefit of Taiwan application serial no. 102136825, filed on Oct. 11, 2013. The entirety of the above-mentioned patent application is hereby incorporated by reference herein and made a part of this specification.

### BACKGROUND OF THE INVENTION

1. Field of the Invention

The invention relates to a wireless communication device, and more particularly, to a wireless communication device and a wireless paring method thereof.

2. Description of Related Art

With improvement of information technologies, various computer systems may now be installed with a plurality of operating systems. For instance, two ore more operation systems such as Microsoft Windows OS and iOS may be installed in one computer at the same time. During a booting process, a user may selectively use one of the operating systems, whereas during an operation of the computer, the user may also selectively decide whether to switch for using another one of the operating systems. Further, a short range wireless communication capability such as Bluetooth and Wireless Fidelity (Wi-Fi) is also supported by some of the computer systems.

However, when a wireless pairing of an operating system (e.g., iOS) of a computer and a bluetooth device (e.g., a bluetooth earphone) is executed by the user, a pair information of the computer and the bluetooth device may be directly used by other operating systems (e.g., Windows XP) on the computer. Accordingly, after the operating system is switched, another wireless pairing needs to be executed by the another operating system, which leads to inconveniences in use.

### SUMMARY OF THE INVENTION

Accordingly, the invention is directed to a wireless communication device and a wireless pairing method thereof, capable of sharing a pairing information between a plurality of operating systems in the wireless communication device for reducing a number time in execute the wireless pairing repeatedly.

The invention provides a wireless paring method for a wireless communication device, and the method is suitable for a first wireless communication device. The first wireless communication device includes a storing module, and the storing module stores a first operation system and a second operating system. The method includes: executing the first operating system, and executing a wireless paring of the first wireless communication device and a second wireless communication device through the first operating system; storing a paring information into a sharing information backup region of the storing module through the first operating system; executing the second operating system, and reading the paring information from the sharing information backup region through the second operating system; and establishing a wireless connection between the first wireless communication device and the second wireless communication device through the second operating system according to the paring information.

The invention also provides a wireless communication device which includes a wireless module, a storing module and a processing module. The storing module is configured to store a first operating system and a second operating system. The processing module is coupled to the storing module and the wireless module. The processing module is configured to execute the first operating system, and control the wireless module through the first operating system to execute a wireless paring of the wireless communication device and another wireless communication device. The processing module is further configured to store a paring information into a sharing information backup region of the storing module through the first operating system. The processing module is further configured to execute the second operating system, and read the paring information from the sharing information backup region through the second operating system. The processing module is further configured to control the wireless module through the second operating system to establish a wireless connection between the wireless communication device and the another wireless communication device.

Based on above, the wireless communication device and the wireless pairing method thereof provided in the invention are capable of storing a pairing information of a wireless communication device and another wireless communication device in a sharing information backup region. When the user switches the operating system of the wireless communication device, the wireless communication device may automatically establish a wireless connection with the corresponding wireless communication device according to the pairing information in the sharing information backup region without repeatedly executing the wireless pairing thereby significantly improve conveniences in use.

To make the above features and advantages of the disclosure more comprehensible, several embodiments accompanied with drawings are described in detail as follows.

### BRIEF DESCRIPTION OF THE DRAWINGS

FIG. 1 is a schematic diagram illustrating a wireless communication device according an exemplary embodiment of the invention.

FIG. 2 is a flowchart illustrating a wireless pairing method for a wireless communication device according an exemplary embodiment of the invention.

FIG. 3 is a schematic diagram illustrating a sharing information backup region according an exemplary embodiment of the invention.

FIG. 4 is a schematic diagram illustrating a sharing information backup region according an exemplary embodiment of the invention.

FIG. 5 is a schematic diagram illustrating a sharing information backup region according an exemplary embodiment of the invention.

### DESCRIPTION OF THE EMBODIMENTS

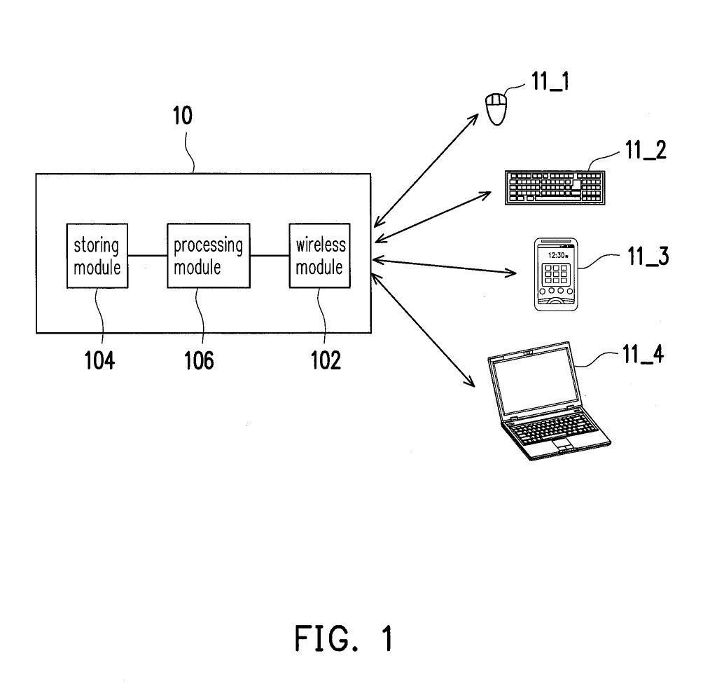

FIG. 1 is a schematic diagram illustrating a wireless communication device according an exemplary embodiment of the invention.

Referring to FIG. 1, a wireless communication device 10 may be an electronic device having wireless communication capability such as a smart phone, a tablet PC, a game console, a notebook computer or a desktop computer, but the invention is not limited thereto. In an exemplary embodiment, the wireless communication device 10 at least supports one of Bluetooth (BT) protocol and Wireless Fidelity (Wi-Fi) protocol, or a combination thereof, or other wireless communication protocols requiring an authentication before a connection can be established, but the invention is not limited thereto.

For instance, the wireless communication device 10 may establish a wireless connection with wireless communication devices 11_1 to 11_1 through bluetooth protocol, respectively, such that, through the wireless connection being established, resources may be shared between the wireless communication devices 11_1 to 11_4, or control signals may be transmitted between the wireless communication device 10 and the wireless communication devices 11_1 to 11_4. For instance, the wireless communication devices 11_1 to 11_4 may be a wireless mouse, a wireless keyboard, the smart phone (or the tablet computer) and the notebook computer, respectively, but the invention is not limited thereto.

The wireless communication device 10 includes a wireless module 102, a storing module 104 and a processing module 106. The wireless module 102 is, for example, a wireless Network Interface Card (wireless NIC) which supports one of Bluetooth (BT) protocol and Wireless Fidelity (Wi-Fi) protocol, or a combination thereof Further, in an exemplary embodiment, the wireless module 102 may also support other wireless communication protocols requiring the authentication before the connection can be established, and the invention is not limited thereto.

The storing module 104 may include various storage mediums such as a Hard Disk Drive (HDD) and a memory, but the invention is not limited thereto. The storing module 104 stores a plurality of operating systems (OS). For instance, the operating systems include Microsoft Windows operating system (e.g., Windows XP, Window 7 and/or Windows 8 and so on), Android operating system, iOS and so on, and the invention is not limited thereto.

The processing module 106 is coupled to the wireless module 102 and the storing module 104. The processing module 106 may be a chip or a chipset capable of processing data, such as a central processing unit (CPU), a micro-processor, an embedded controller, and the invention is not limited thereto.

For the convenience of explanation, the invention is illustrated hereinafter by assuming that the storing module 104 is stored with a first operating system and a second operating system. The first operating system is Window 8 for example, and the second operating system is iOS for example.

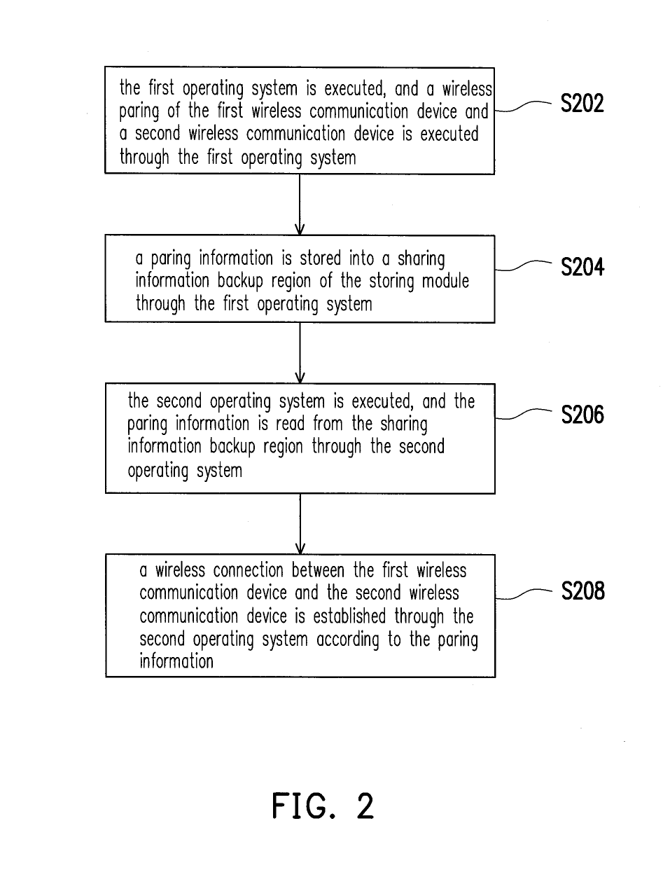

FIG. 2 is a flowchart illustrating a wireless pairing method for a wireless communication device according an exemplary embodiment of the invention.

Referring to FIG. 1 and FIG. 2 together, in step S202, the process module 106 executes the first operating system. For instance, in case the processing module 106 may only execute one operating system at the same time in an exemplary embodiment, in step S202, the processing module 106 may only execute the first operating system, or maintain the first operating system in a normal operating mode, while making the second operating system to enter a hibernate mode. Furthermore, in case the processing module 106 may execute two or more operating systems at the same time in an exemplary embodiment, in step S202, the processing module 106 may maintain both the first operating system and the second operating system in the normal operating mode, in which the operating system where major operations are executed is set to the first operating system.

Next, the processing module 106 executes the first operating system, and executes a wireless paring of the wireless communication device 10 and another wireless communication device (e.g., the wireless communication devices 11_1 to 11_4) through the first operating system. For instance, the processing module 106 may control the wireless module 102 through the first operating system to search the another wireless communication device (e.g., the wireless communication devices 11_1 to 11_4) within a specific range near the wireless communication device 10. Said specific range is depended on an intensity of a wireless signal transmitted by the wireless module 102, and the intensity of the wireless signal may be adjusted according to practical demands.

In an exemplary embodiment, it is assumed that the wireless communication device 11_1 is within the specific range, and a function for the wireless communication device to be searched is activated, so that the wireless communication device 11_1 may be searched by the wireless communication device 10. When the wireless communication device 11_1 is searched by the processing module 106 (or the wireless module 102), the processing module 106 may execute the wireless pairing of the wireless communication device 10 and the wireless communication device 11_1 through the first operating system.

For instance, during the wireless pairing (e.g., a bluetooth pairing) of the wireless communication device 10 and the wireless communication device 11_1, the processing module 106 may obtain a Media Access Control address (MAC address) of the wireless module 102 and/or a MAC address of the wireless communication device 11_1 through the first operating system, and generate a link key according to the MAC address of the wireless module 102 and/or a MAC address of the wireless communication device 11_1. For instance, the link key may be a random number generated based on the MAC address of the wireless module 102 and/or a MAC address of the wireless communication device 11_1 through an encrypting device or a random number generator. In other words, the link key may be used in the authentication between the wireless communication device 10 and the wireless communication device 11_1 for confirming authorizations of each other. Based on the link key, the processing module 106 may further control the wireless module 102 through the first operating system to establish a wireless connection between the wireless module and the wireless communication device 11_1.

Further, based on a pairing result of the wireless pairing, the processing module 106 may obtain a pairing information of the wireless pairing through the first operating system. In other words, the pairing information includes the link key and the pairing device information. The link key is generated during the wireless pairing, and the pairing device information records, for example, a device information for identifying the wireless communication device 11_1 such as the MAC address and/or a device name of the wireless communication device 11_1.

In other words, for the first operating system, the pairing information corresponding to the wireless communication device 11_1 may be obtained simply by executing one wireless pairing with the wireless communication device 11_1. When the next time it is required to establish the wireless connection with the wireless communication device 11_1, according to said pairing information, the first operating system may quickly obtain the link key, the MAC address and/or the device name and related connection settings of the wireless communication device 11_1 which are required for establishing the wireless connection. Accordingly, the wireless connection between the wireless communication device 10 and the wireless communication device 11_1 may be established without executing the wireless pairing again.

Next, in step S204, the processing module 106 may store the paring information into a sharing information backup region of the storing module 104 through the first operating system. For instance, both the first operating system and the second operating system may have accesses to read and write data in the sharing information backup region. Or, in an exemplary embodiment, data written by a specific operating system may be protected by a specific write lock mechanism, so as prevent the data from being deleted by other operating system by mistake, but the invention is not limited thereto.

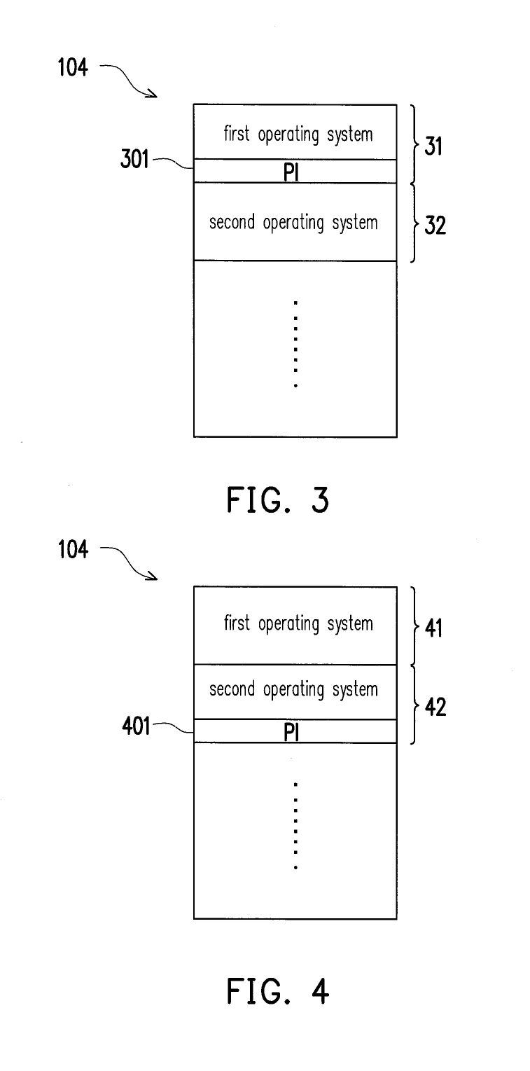

FIG. 3 is a schematic diagram illustrating a sharing information backup region according an exemplary embodiment of the invention.

Referring to FIG. 1 and FIG. 3 together, in an exemplary embodiment, the storing module 104 includes a system partition 31 and a system partition 32. The system partition 31 and the system partition 32 may be located on the same or different hard disk or memory, and the invention is not limited thereto. The system partition 31 stores the first operating system (OS) (e.g., Windows 8), and the system partition 32 stores the second operating system (e.g., iOS).

In the present exemplary embodiment, the processing module 106 establishes a sharing information backup region 301 in the system partition 31. After a pairing information PI of the wireless connection is obtained by the first operating system, the processing module 106 may store the pairing information PI in the sharing information backup region 301 through the first operating system. In addition, the sharing information backup region 301 may be established in advance, or established by the processing module 106 through the first operating system when the pairing information PI of the wireless connection is obtained.

FIG. 4 is a schematic diagram illustrating a sharing information backup region according an exemplary embodiment of the invention.

Referring to FIG. 1 and FIG. 4 together, in an exemplary embodiment, the storing module 104 includes a system partition 41 and a system partition 42. The system partition 41 and the system partition 42 may be located on the same or different hard disk or memory, and the invention is not limited thereto. The system partition 41 stores the first operating system (OS) (e.g., Windows 8), and the system partition 42 stores the second operating system (e.g., iOS).

In the present exemplary embodiment, the processing module 106 establishes a sharing information backup region 401 in the system partition 42. After a pairing information PI of the wireless connection is obtained by the first operating system, the processing module 106 may store the pairing information PI in the sharing information backup region 401 through the first operating system. In addition, the sharing information backup region 401 may be established in advance, or established by the processing module 106 through the first operating system when the pairing information PI of the wireless connection is obtained.

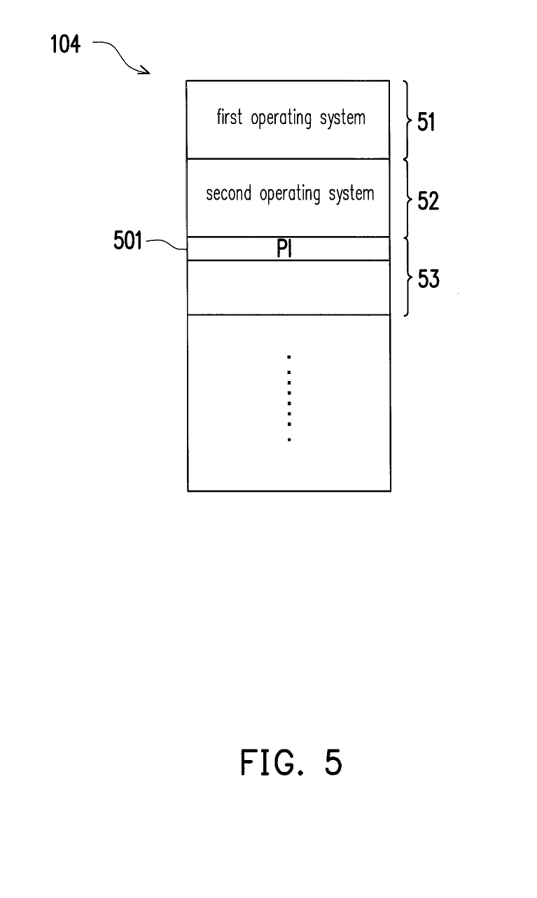

FIG. 5 is a schematic diagram illustrating a sharing information backup region according an exemplary embodiment of the invention.

Referring to FIG. 1 and FIG. 5 together, in an exemplary embodiment, the storing module 104 includes system partitions 51 to 53. The system partitions 51 to 53 may be located on the same or different hard disk or memory, and the invention is not limited thereto. The system partition 51 stores the first operating system (OS) (e.g., Windows 8), the system partition 52 stores the second operating system (e.g., iOS) and the system partition 53 may be configured to store the rest of system information (e.g., a management table and so on) and user data.

In the present exemplary embodiment, the processing module 106 establishes a sharing information backup region 501 in the system partition 53. After a pairing information PI of the wireless connection is obtained by the first operating system, the processing module 106 may store the pairing information PI in the sharing information backup region 501 through the first operating system. In addition, the sharing information backup region 501 may be established in advance, or established by the processing module 106 through the first operating system when the pairing information PI of the wireless connection is obtained.

Referring back to to FIG. 1 and FIG. 2, in step S206, the process module 106 executes the second operating system. For instance, in case the processing module 106 may only execute one operating system at the same time in an exemplary embodiment, in step S206, the processing module 106 may make the first operating system to enter the hibernate mode and continue to execute the second operating system after the first operating system entered the hibernate mode. Or, in case the processing module 106 may execute two or more operating systems at the same time in an exemplary embodiment, in step S206, the processing module 106 may synchronously execute the second operating system when the first operating system is maintained in the normal operating mode. For instance, the processing module 106 may maintain both the first operating system and the second operating system in the normal operating mode, in which the operating system where major operations are executed is switched from the first operating system to the second operating system. Next, the processing module 106 reads the paring information from the sharing information backup region (e.g., the sharing information backup regions 301, 401 and 501) through the second operating system.

Next, in step S208, the processing module 106 establishes a wireless connection between the wireless communication device 10 and the wireless communication device 11_1 through the second operating system according to the paring information.

Generally, the pairing information corresponding to the wireless communication device 11_1 is obtained by the processing module 106 through the first operating system. Therefore, in case the processing module 106 shuts down the first operating system and only execute the second operating system, or switch the operating system where major operations are executed from the first operating system to the second operating system, the second operating system cannot establish the wireless connection with the wireless communication device 11_1 directly through the pairing information. Instead, the wireless pairing with the wireless communication device 11_1 needs to be executed again through the second operating system in order to obtain the pairing information. However, the pairing information obtained by the first operating system is stored in the sharing information backup region (e.g., the sharing information backup regions 301, 401, 501) in advance through the first operating system. Therefore, in step S208, the second operating system may skip the wireless pairing which is required to be executed in conventional art and directly read the pairing information from the sharing information backup region, so as to control the wireless module 102 to establish the wireless connection between the wireless communication device 10 and the wireless communication device 11_1 according to the pairing information.

For instance, when the second operating system is set by the processing module 106 as the operating system where major operations are executed, the processing module 106 may search the pairing device information in the pair information through the second operating system, and control the wireless module 102 to search and determine whether the wireless communication device 11_1 recorded in the pairing device information is nearby. In case the wireless communication device 11_1 is nearby, the link key, the MAC address, the device name and the related connection settings of the wireless communication device 11_1 in the pairing information may be directly used to establish the wireless connection between the wireless communication device 10 and the wireless communication device 11_1.

Nonetheless, it should be noted that, the exemplary embodiment above is illustrated with the bluetooth connection of the wireless communication device 11_1 (e.g., the wireless mouse) as an example. However, in an exemplary embodiment, it is assumed that other function supported by Wi-Fi protocol such as a hot spot is activated by the wireless communication devices 11_3 or 11_4, so that the wireless communication device 10 (or the processing module 106) may execute a wireless pairing based on Wi-Fi protocol with the wireless communication devices 11_3 or 11_4 through the first operating system. Accordingly, when the wireless communication device 10 (or the processing module 106) executes the second operating system (e.g., the second operating system is set to the operating system where the major operations are executed or only the second system is executed), the pairing information stored in the sharing information backup region (e.g., the sharing information backup regions 301, 401 and 501) by the first operating system in advance may be read through the second operating system. Subsequently, the second operating system may control the wireless module to establish a Wi-Fi connection with the wireless communication devices 11_3 or 11_4 according to the pairing information, so as to skip a complex re-pairing process when switching between operating systems in conventional art. Further, in an exemplary embodiment, the invention is also suitable for other wireless communication protocols requiring the authentication before the connection can be established.

It should be noted that, in an exemplary embodiment, the processing module 106 may include corresponding hardware circuits for executing functions proposed in each exemplary embodiment described above. Or, in an exemplary embodiment, the storing module 104 may also store corresponding software or firmware modules, such that after the corresponding software or firmware modules are loaded in the processing module 106 for execution, the processing module 106 may execute steps and methods described in the foregoing exemplary embodiments.

Based on above, the wireless communication device and the wireless pairing method thereof according to the invention are capable of storing a pairing information of a wireless communication device and another wireless communication device in a sharing information backup region. When the user switches the operating system of the wireless communication device, the wireless communication device may automatically establish a wireless connection with the corresponding wireless communication device according to the pairing information in the sharing information backup region without repeatedly executing the wireless pairing thereby significantly improve conveniences in use.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

1. A wireless paring method for a wireless communication device, suitable for a first wireless communication device, the first wireless communication device having a storing module, the storing module storing a first operating system and a second operating system, and the wireless paring method for the wireless communication device comprising:
executing the first operating system, and executing a wireless paring of the first wireless communication device and a second wireless communication device through the first operating system;
storing a paring information into a sharing information backup region of the storing module through the first operating system;
executing the second operating system, and reading the paring information from the sharing information backup region through the second operating system; and
establishing a wireless connection between the first wireless communication device and the second wireless communication device through the second operating system according to the paring information.

2. The wireless paring method for the wireless communication device of claim 1, wherein executing the wireless paring of the first wireless communication device and the second wireless communication device through the first operating system comprises:
searching the second wireless communication device within a specific range near the first wireless communication device through the first operating system;
executing the wireless paring of the first wireless communication device and the second wireless communication device through the first operating system when the second wireless communication device is searched; and
obtaining the pairing information of the wireless paring through the first operating system according to a pair result of the wireless pairing, wherein the pairing information comprises a link key and a pairing device information.

3. The wireless paring method for the wireless communication device of claim 1, wherein the first operating system is stored in a first system partition of the storing module, the second operating system is stored in a second system partition of the storing module, and the wireless paring method further comprises:
establishing the sharing information backup region in one among the first system partition, the second system partition, and a third system partition of the storing module.

4. The wireless paring method for the wireless communication device of claim 1, wherein executing the second operating system comprises:
making the first operating system to enter a hibernate mode; and
executing the second operating system after the first operating system entered the hibernate mode.

5. The wireless paring method for the wireless communication device of claim 1, wherein executing the second operating system comprises:
maintaining the first operating system in a normal operating mode; and
synchronously executing the second operating system when the first operating system is maintained in the normal operating mode.

6. A wireless communication device, comprising:
a wireless module;
a storing module configured to store a first operating system and a second operating system; and
a processing module coupled to the storing module and the wireless module,
wherein the processing module is configured to execute the first operating system, and control the wireless module through the first operating system to execute a wireless paring of the wireless communication device and another wireless communication device,
wherein the processing module is further configured to store a paring information into a sharing information backup region of the storing module through the first operating system,
wherein the processing module is further configured to execute the second operating system, and read the paring information from the sharing information backup region through the second operating system,
wherein the processing module is further configured to control the wireless module through the second operating system to establish a wireless connection between the wireless communication device and the another wireless communication device.

7. The wireless communication device of claim 6, wherein the processing module is further configured to control the wireless module through the first operating system to search the another wireless communication device within a specific range near the wireless communication device,
the processing module is further configured to control the wireless module through the first operating system to execute the wireless paring of the wireless communication device and the another wireless communication device when the another wireless communication device is searched,
wherein the processing module is further configured to obtain the pairing information of the wireless paring according to a pair result of the wireless pairing, wherein the pairing information comprises a link key and a pairing device information.

8. The wireless communication device of claim 6, wherein the first operating system is stored in a first system partition of the storing module, the second operating system is stored in a second system partition of the storing module,
wherein the processing module is further configured to establish the sharing information backup region in one among the first system partition, the second system partition, and a third system partition of the storing module.

9. The wireless communication device of claim 6, wherein the processing module is further configured to make the first operating system to enter a hibernate mode, and execute the second operating system when the first operating system entered the hibernate mode.

10. The wireless communication device of claim 6, wherein the processing module is further configured to maintain the first operating system in a normal operating mode, and synchronously execute the second operating system when the first operating system is maintained in the normal operating mode.
